(19) United States
(12) Patent Application Publication
(10) Pub. No.: US 2016/0167301 A1
(43) Pub. Date: Jun. 16, 2016

(54) POLYMERIC PHOTOINITIATORS FOR 3D PRINTING APPLICATIONS

(71) Applicant: Autodesk, Inc., San Rafael, CA (US)

(72) Inventors: Michael Cole, Boulder, CO (US); Neil Cramer, Boulder, CO (US); Amelia Davenport, Boulder, CO (US)

(21) Appl. No.: 14/967,055

(22) Filed: Dec. 11, 2015

Related U.S. Application Data
(60) Provisional application No. 62/091,460, filed on Dec. 12, 2014.

(51) Int. Cl. B29C 67/00; C08F 122/10

(52) U.S. Cl. CPC B29C 67/0066; C08F 122/105; B29K 2105/0002

(57) ABSTRACT

The use life of windows (e.g., PDMS windows) for 3D SLA printers can be been extended by the incorporation of more polar photoinitiators and higher molecular weight photoinitiators into the resin. The degradation of the window, usually seen as cloudiness, has been shown to be from polymerization of the resin within the window material, and by using either polar or high molecular weight photoinitiators that are much less soluble in the window material, the degradation from polymerization in the window can be greatly reduced, thus extending the life of the window material. The extension of use life for the window when using the photoinitiators described herein can even occur when the resin has significant solubility in the window material, which also allows use of nonpolar resins that often have advantages over polar resins (viscosity and water uptake).

### CROSS-REFERENCE TO RELATED APPLICATION

This application claims priority to U.S. Provisional Application No. 62/091,460, filed on Dec. 12, 2014. The disclosure of the prior application is considered part of and is incorporated by reference in the disclosure of this application.

### BACKGROUND

This specification relates to three dimensional (3D) printing using photopolymers, stereolithographic (SLA) printing and the resins and photoinitiators used in 3D printing devices.

In recent years there has been a large increase in the number and type of 3D printers available to the hobbyist, jewelry makers, and consumers. A certain subsection of these SLA 3D printers use a configuration that requires light to be transmitted from underneath, through a transparent material (called the window), into the resin whereby the resin is cured, usually in thin layers. A few examples of such printers are the FormLabs Form 1+3D printer, the Pegasus Touch Laser 3D Printer by Full Spectrum Laser, the Solidator 3D Printer by Solidator, etc. The resin contains pigments or dyes that absorb (and/or scatter) light at the wavelength used to cure the resin. The window material needs to be transparent, free from optical defects, and inert to the resin especially during the curing of the resin. The most common window material is PDMS (polydimethylsiloxane).

PDMS has great oxygen solubility and diffusion rates, which means that a free radical polymerization near a PDMS surface is inhibited by the diffusion of oxygen (a natural free radical polymerization inhibitor) out of the PDMS into the resin. When a light to which the resin is sensitive is directed into the resin, the resin cures, and ideally a layer of uncured resin is left at the PDMS window. The uncured resin layer prevents adhesion to the PDMS.

Adhesion to the PDMS can occur when either too large of an intensity is used (thus overcoming the diffusion of oxygen out of the PDMS), when a resin or polymerization mechanism that is not inhibited by oxygen is used (examples such as thiol-ene free radical polymerizations, or ionic polymerizations), and/or when one or more monomers of the resin have appreciable solubility in the PDMS resin.

Other window materials have been used other than PDMS, such as transparent fluorinated materials which also have high oxygen diffusion rates; however, the fluorinated materials tend to be more expensive and thus are not used as often. In general, no matter what the window material is composed of, the mechanism for creating an inhibited layer next to the window is almost always the use of oxygen diffusion into a free radically polymerized resin.

One of the issues with using such window materials and especially when using PDMS is that the window properties degrade with use. Some issues that are commonly seen after polymerizing 100s or 1000s of layers against the window are hazing or clouding inside the window, clouding or hazing on the surface of the window, and an increase in the adhesion of the resin to the window. The first two issues cause a decrease in the x, y, and z resolution of the part being printed and eventually cause the print to fail. The third issue also causes the print to fail by either the part sticking to the window and not progressing to the subsequent layers, or upon separation of the cured resin from the window, the PDMS is torn or pitted.

Resin development to date has concentrated on use of polar monomers which have a very low solubility in the PDMS (or fluorinated) windows. This tactic has been shown to increase the life of the PDMS window, though at the price of higher viscosity, which causes some printers to hang up or slow down the print time.

### SUMMARY

This specification describes technologies relating to three dimensional (3D) printing and extending the life of PDMS and similar windows.

According to some implementations, the resin for SLA 3D printers contains a photoinitiator component in which at least one component of the photoinitiator component is polar. The photoinitiator component can contain at least one component that has polar groups that lower the solubility of that said photoinitiator component in hydrophobic window materials. In addition, according to some implementations, the resin for SLA 3D printers contains a photoinitiator component whereby at least one component of the photoinitiator component is of a molecular weight greater than 450 g/mole. Further, according to some implementations, the resin for SLA 3D printers contains a photoinitiator component whereby at least one component of the photoinitiator component is of a molecular weight greater than 450 g/mole and is polar.

Embodiments of the subject matter described in this specification can be implemented to realize one or more of the following advantages. Adhesion at the resin-window interface in a photopolymer-based 3D printer can be reduced, thereby reducing or eliminating the undesirable force that may otherwise be needed to separate the window and polymer. This can result in a reduced failure rate and improved 3D prints. Less expensive materials can be used for the window, and/or the useable lifetime of the window can be extended. In addition, in some implementations, such advantages can be realized without a significant increase in the viscosity of the resin, resulting in improved printer performance, including reduced print time.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a 3D printing system.

FIG. 2 shows an example of a TPO derivative.

Like reference numbers and designations in the various drawings indicate like elements.

### DETAILED DESCRIPTION

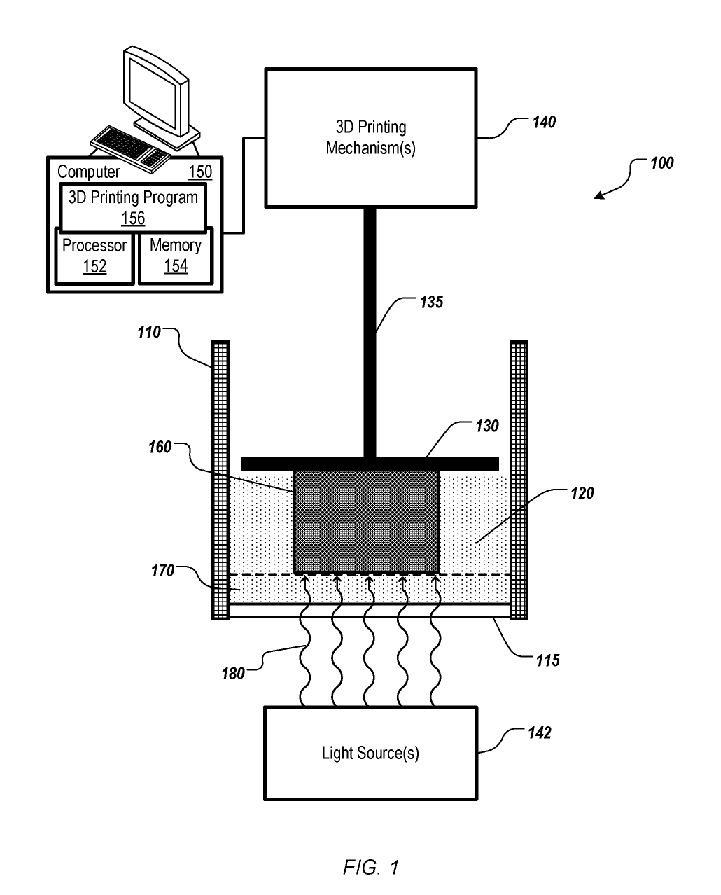

FIG. 1 shows an example of a 3D printing system 100. The system 100 includes a vat or reservoir 110 to hold a resin 120, which is made up of various chemicals. The vat 110 includes a window 115 in its bottom through which illumination is transmitted to cure a 3D printed part 160. The 3D printed object 160 is shown as a block, but as will be appreciated, a wide variety of complicated shapes can be 3D printed. In addition, although systems and techniques are described herein in the context of reducing adhesion forces at a window at a bottom of a liquid filled vat, it will be appreciated that other configurations are possible for reducing adhesion forces at a window-resin interface when 3D printing using photopolymers.

The object 160 is 3D printed on a build plate 130, which is connected by a rod 135 to one or more 3D printing mechanisms 140. The printing mechanism(s) 140 can include various mechanical structures for moving the build plate 130 within the vat 110. This movement is relative movement, and thus the moving piece can be the build plate 130, the vat 110, or both, in various implementations. In some implementations, a controller for the printing mechanism(s) 140 is implemented using integrated circuit technology, such as an integrated circuit board with embedded processor and firmware. Such controllers can connect with a computer or computer system. In some implementations, the system 100 includes a programmed computer 150 that connects to the printing mechanism(s) 140 and operates as the controller for the system 100.

A computer 150 includes a processor 152 and a memory 154. The processor 152 can be one or more hardware processors, which can each include multiple processor cores. The memory 154 can include both volatile and non-volatile memory, such as Random Access Memory (RAM) and Flash RAM. The computer 150 can include various types of computer storage media and devices, which can include the memory 154, to store instructions of programs that run on the processor 152. For example, a 3D printing program 156 can be stored in the memory 154 and run on the processor 152 to implement the techniques described herein.

One or more light sources 142 are positioned below the window 115 and are connected with the computer 150 (or other controller). The light source can include any source of electromagnetic radiation of any wavelength. The light source can be monochromatic, multi-wavelength, or broadband. A few non-limiting examples of typical light sources are LEDs, lasers, and high pressure mercury lamps.

Referring to FIG. 1, the light source(s) direct a light 180 into the resin 120 through the window 115. The light 180 has a wavelength that is used to create the 3D structure 160 on the build plate 130 by curing the resin 120 within a photoinitiation layer 170, in accordance with a defined pattern or patterns.

The window 115 refers to the optically clear portion of the resin tray that allows light from the light source to pass into the resin. Ideally, it is completely transparent to the wavelength used to cure the resin. The window typically has a high modulus plastic or glass bottom to which a softer (oxygen permeable) material is layer is adhered on top. The softer material typically is PDMS. Other materials and configurations are possible such as use of fluorinated materials as the window either with or without the glass/plastic backing.

The build plate 130 starts at a position near the bottom of the vat 110, and a varying pattern of the light 180 is then directed through the window 115 to create the solid structure 160 as the build plate 130 is raised out of the vat. The build plate 130 can also be referred to as the “build platform,” which refers to the part of the printer that is connected to a motor for z axis control (relative to the window surface), and it may also move in x and y directions. Upon the first exposure through the window, the resin cures and preferentially sticks to the build platform and not to the window with every subsequent layer adhering to a previously cured layer and not to the window.

In addition, the computer 150 (or other controller) can change a thickness of the photoinitiation layer 170. In some implementations, this change in layer thickness(es) can be done for each new 3D print based on the type of 3D print to be performed. The layer thickness can be changed by changing the strength of the light source, the exposure time, or both. In some implementations, this change in layer thickness(es) can be performed during creation of the solid structure 160 based on one or more details of the structure 160 at one or more points in the 3D print. For example, the layer thickness can be changed to add greater Z details in layers that require it.

The resin 120 can include one or more of a polymerizable component, photoinitiating components, dyes, pigments, optical absorbers, binders, and polymerization inhibitors. Minimally, a resin contains a polymerizable component and a photoinitiator component. In some implementations, a resin contains at least a polymerizable component, a photoinitiator component, and an optical absorber. It is also possible that the resin may contain filler materials such as silica, clay, polymer microspheres, plasticizers, and nonreactive binders. This list not meant to be limiting and other inert compounds can be used and still fall within the scope of the present disclosure.

Polymerizable functional group or reactive group may refer to any functional group capable of free radical polymerization or copolymerization. Examples of such groups are acrylates, methacrylates, styrenes, maleates, fumarates, maleimides, thiols, vinyl ethers, ring opening spirocompounds, or other free radically polymerizable functional groups. In general, free radically polymerizable groups contain unsaturation such as a double or triple bond, but can also comprise a chain transfer agent.

Polymerizable component may refer to the part of the resin that polymerizes. The polymerizable component is comprised of one or more monomers. The monomers will have at least one polymerizable functional group. Monomers may be mixtures of different types of polymerizable functional groups such as methacrylates and acrylates, maleates and methacrylates, vinyl ether and fumarates, etc., and may have more than two types of polymerizable functional groups present in the polymerizable component. Monomers may be of any molecular weight or shape (i.e., linear, spherical, dendritic, branched, etc.).

Optical absorber may refer to any molecule that absorbs or scatters the light used to initiate photopolymerization. Such molecules are often called optical absorbers, dyes, pigments, optical brighteners, fluorophores, chromophores, UV blockers, etc. Independent of the common name used, the function is to block, absorb, or scatter the light used to initiate the polymerization of the resin. Some example optical absorbers are carbon black, spiropyran dyes (i.e., 1′,3′-Dihydro-8-methoxy-1′,3′,3′-trimethyl-6-nitrospiro[2H-1-benzopyran-2,2′-(2H)-indole]—which also gives a color changing printed part upon exposure to blue or ultraviolet light), coumarins, benzoxazoles (i.e., 2,2′-(2,5-thiophenediyl)bis(5-tert-butylbenzoxazole)), benzotriazoles (i.e., 2-[3-(2H-Benzotriazol-2-yl)-4-hydroxyphenyl]ethyl methacrylate), titania particles, etc. Whenever possible, it may be advantageous to have a polymerizable functional group on the optical absorber, or have the optical absorber be of high molecular weight, both of which decrease the migration of the optical absorber out of the printed part after cure.

Dyes and pigments may refer to the parts of the resin that add color, fluorescence, or phosphorescence to the printed part. They may be added in addition to the optical absorbers and may also function as optical absorbers.

Binders may refer to one or more thermoplastic materials. Binders typically have molecular weights greater than 1000 g/mole and are not crosslinked, though they may be dendritic. Binders are useful for reducing shrinkage stress in the cured part by decreasing the concentration of the polymerizable functional group. They also can be used to modify the various other properties of the resin such as elongation, modulus, hardness, etc.

Reactive binder may refer to binders that have reactive functional group(s) either in the backbone or pendant to the chain. The reactive group(s) allows the binder to polymerize or copolymerize with the monomers present in the resin. Some reactive binders will not be solids at room temperature and thus will not follow the usual definition of binder (defined as a thermoplastic).

Oligomer may refer to a molecule that has between 2 and 10 repeat units and a molecular weight greater than 300 g/mole. Such oligomers may contain one or more polymerizable groups whereby the polymerizable groups may be the same or different from other possible monomers in the polymerizable component. Furthermore, when more than one polymerizable group is present on the oligomer, they may be the same or different.

Additionally, oligomers may be dendritic.

Photoiniator may refer to the conventional meaning of the term photoinitiator and may also refer to sensitizers and dyes. In general, a photoinitiator causes the curing of a resin when the resin containing the photoinitiator is exposed to light of a wavelength that activates the photoinitiator. The photoinitiator may refer to a combination of components, some of which individually are not light sensitive, yet in combination are capable of curing the photoactive monomer; examples are dye/amine, sensitizer/iodonium salt, dye/borate salt, etc.

Plasticizers may refer to the conventional meaning of the term plasticizer. In general, a plasticizer is a compound added to a polymer both to facilitate processing and to increase the flexibility and/or toughness of a product by internal modification (solvation) of a polymer molecule. Plasticizers also function to lower the viscosity of the initial resin. Typical plasticizers are compounds with low volatility such as dibutyl phthalate, various poly(phenylmethylsiloxanes), petroleum ethers, low molecular weight poly(ethyleneglycol), etc.

Thermoplastic may refer to the conventional meaning of thermoplastic, i.e., a polymer that softens and melts when heated and that returns to a solid cooled to room temperature. Examples of thermoplastics include, but are not limited to: poly(methyl vinyl ether-alt-maleic anhydride), poly(vinyl acetate), poly(styrene), poly(propylene), poly(ethylene oxide), linear nylons, linear polyesters, linear polycarbonates, linear polyurethanes, etc.

When a standard photoinitiator is used, it too has some solubility in the window material. When the window is exposed to the light source, the photoinitiator is activated and produces radicals. These radicals are typically scavenged by oxygen, but occasionally, they do react with monomer that is also present in the window. Over many exposures, the buildup of partially polymerized monomers both internally to the window and at the surface, causes clouding. Internal cloudiness is from phase separation of the polymerized monomers inside the window. Surface cloudiness is typically caused by pitting of the surface which happens when the adhesion to the window is stronger than the window material, causing a small portion of the window to tear off. Sometimes, the adhesion increases fast enough to cause damage to the window before surface clouding can be seen. In all these scenarios, the main cause of the issue is both monomer and photoinitiator solubility in the window. Some background information on solubility of different compounds in PDMS materials may be found in Lee, J. N.; Park, C.; Whitesides, G. M. (2003), “Solvent Compatibility of Poly(dimethylsiloxane)-Based Microfluidic Devices,” Anal. Chem. 75 (23):6544-6554 and McDonald, J. C.et al. (2000), “Fabrication of microfluidic systems in poly(dimethylsiloxane),” Electrophoresis 21 (1):27-40.

Resins used in 3D SLA printers generally rely on standard small molecule photoinitiators such as TPO (Diphenyl(2,4,6-trimethylbenzoyl)phosphine oxide), or UV photoinitiators such as Irgacure 184 (1-Hydroxycyclohexyl phenyl ketone). However, it has been found that such small molecules have some solubility in windows like PDMS.

Therefore, according to a first implementation of this disclosure, a photoinitiator can be used that has polar functionality that greatly decreases its solubility in hydrophobic windows such as PDMS. Such polar functionality can be selected from hydroxyls, nitriles, carbonates, amides, urethane, ureas, sulfones, sulfoxides, amines, phosphates, carboxylic acids, sulfonic and sulfuric acids, phosphinic acids, as well as ionic salts such as lithium salts, sodium salts, potassium salts, calcium salts. This list is not limiting and is only a means to suggest possible polar groups that can be used. In general, the addition of the polar groups is meant to increase the solubility parameter of the photoinitiator such that is becomes very insoluble in the window. For example, PDMS has a Hildebrand solubility parameter of about 15 MPa^{0.5}, so materials with a Hildebrand solubility parameter greater than 20 MPa^{0.5}, more preferably greater than 25 MPa^{0.5}, and most preferably greater than 30 MPa^{0.5}. It is known that Hildebrand solubilities should only be used as a general guide when determining solubility as they do not take into account hydrogen bonding and other factors. The Hansen solubility parameter may be used to make more accurate solubility predictions.

However, the best method may be by direct determination of solubility in the window material such as by soaking the window in the compound of question and comparing before soaking with after soaking to determine the percent uptake in the window. It may be preferable that the photoinitiator have a solubility less than 1 wt %, preferable is less than 0.5 wt %, more preferable is less than 0.25 wt %, most preferable is less than 0.1 wt %. In some cases, the other resin components can increase the solubility of the photoinitiator in the window. This can occur when other components of the resin have some solubility in the window and thus change the solubility parameter of the window. In these cases, the solubility of the photoinitiator can be measured using UV-Vis spectroscopy. A window is soaked in the resin (usually without UV blockers/abosrbers or dyes) for more than 24 hours (preferably until the UV-Vis spectrum stabilizes) and then the spectrum of before and after soaking is compared. Using the molar absorptivity of the photoinitiator, the concentration of the photoinitiator can be calculated.

The polymerizable component of the resin 120 can be made from free radically polymerizable monomers (and includes polymerizable oligomers and/or polymers). Monomers may be monofunctional, difunctional, and/or multifunctional or mixtures of functionality and/or polymerizable group. Monomers may be mixtures of several different monomers, which contain different functionalities and/or different polymerizable groups. Preferred polymerizable groups may include acrylates, methacrylates, maleates, and fumarates. It may also be preferred that the monomers be polar when used in conjunction with a nonpolar window such as PDMS.

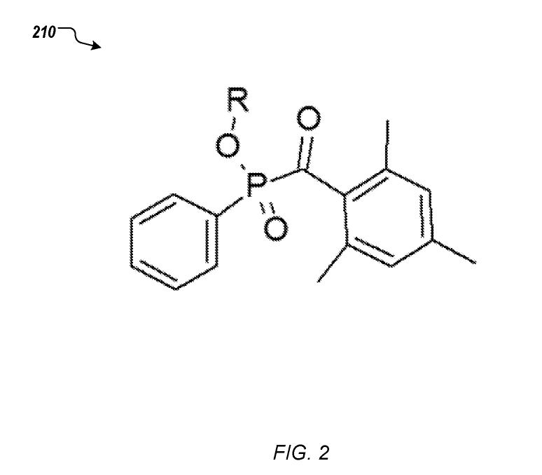

Photoinitiators based on the present disclosure can fall into three categories: polar or high molecular weight or both. As a class, polar photoinitiators contain one or more polar groups and have very little solubility in PDMS when in a resin. An example of a TPO derivative 210 is shown in FIG. 2 and the synthesis of the lithiated derivative can be found in Biomaterials 2009, 30(35), pg 6702; and the sodium derivative here Dental Materials Journal 2009; 28(3):267-276. Referring to FIG. 2, R can be a positive cation such as Li, Na, K, Ca, Fe, Ti, etc., and can also be a sugar fragment or a sugar derivative.

Other examples of polar photoinitiators can be found in U.S. Pat. No. 5,998,496 (S. A. Hassoon, et. al.) which discloses salt versions of benzophenones, xanthones, fluorones, acetophenones, coumarins and various other absorbing species that can be used to initiate polymerization.

The second category of photoinitiators is high molecular weight photoinitiators. In this case, photoinitiators with molecular weights greater than 300 g/mole are considered. In some cases, the molecular weight of the photoinitiator may be greater than 500 g/mole. In some cases, the molecular weight may be greater than 1000 g/mole. In some cases, the molecular weight of the photoinitiators may be greater than 1500 g/mole.

Examples of high molecular weight photoinitiators may be seen in the following: Yu Chen, et al. “Novel multifunctional hyperbranced polymeric photoinitiators with built in amine coinitiators for UV curing,” Journal of Materials Chemistry, 2007,17, pg. 3389; Wei, J., Wang, H., Jiang, X. and Yin, J. (2006), “A Highly Efficient Polyurethane-Type Polymeric Photoinitiator Containing In-chain Benzophenone and Coinitiator Amine for Photopolymerization of PU Prepolymers,” Macromol. Chem. Phys., 207:2321-2328; Temel, G., Karaca, N. and Arsu, N. (2010), “Synthesis of main chain polymeric benzophenone photoinitiator via thiol-ene click chemistry and its use in free radical polymerization,” J. Polym. Sci. A Polym. Chem., 48:5306-5312; T. Corrales et al., Journal of Photochemistry and Photobiology A: Chemistry 159 (2003) 103-114.

Examples of polymeric and dendritic photoiniators may be seen in U.S. Patent 2012/0046376 (Loccufier et al.).

Commercial high molecular weight photoinitiators may include the following: Omnipol 2702 (cas no. 1246194-73-9), Omnipol 2712, Omnipol 682 (cas no. 515136-49-9), Omnipol 910 (cas no. 886463-10-1), Omnipol 9210 (cas no. 886463-10-1 +51728-26-8), Omnipol ASA (cas no. 71512-90-8), Omnipol BP (cas no. 515136-48-8), Omnipol TX (cas no. 813452-37-8).

Other examples of useful photoiniators include the phosphine oxide based macrophotoinitiators presented in T. Corrales et al., Journal of Photochemistry and Photobiology A: Chemistry 159 (2003) 103-114. Also useful are the synthetic routes shown in the following reference which can be used to make polar, oligomeric, or polymeric bisphosphine oxides derivatives: Gonsalvi, L. and Peruzzini, M. (2012), “Novel Synthetic Pathways for Bis(acyl)phosphine Oxide Photoinitiators,” Angew. Chem. Int. Ed., 51:7895-7897.

The concentration of the photoinitiator component can range from 0.1 wt % to 30 wt % depending on the structure and reactivity of the photoinitiator component. In general, low molecular weight polar photoinitiators require lower concentrations, whereas high molecular weight photoinitiators typically require higher concentrations. Higher than 30 wt % of the photoinitiator component is possible and in some cases useful, but in general can lead to an increase in viscosity.

In most implementations, photoinitiators in the photoinitiator component of the present disclosure are sensitive to ultraviolet and visible radiation from 200 nm to 800 nm.

Preferably, the photoinitiator component may be sensitive to radiation from 200 nm to 480 nm, and in some cases from 350 nm to 410 m.

The foregoing can further be illustrated in the following non-limiting examples.

### EXAMPLE 1

A resin of the following composition was made:
76 wt % Dimethylol tricyclodecane diacrylate
19 wt % Tripropyleneglycol diacrylate
3.8 wt % 2-[3-(2H-Benzotriazol-2-yl)-4-hydroxyphenyl]ethyl methacrylate
1.2 wt % TPO photinitiator,

The resin was made on a printer with an intensity of 18 mW/cm² (from a 405 nm LED), and 600 layers were printed at which time there was a very visible cloudiness to the PDMS window (Sylgard 184). TCDDA swells PDMS about 4 wt %, TPGDA swells PDMS about 3 wt % both of which are considered high. The 2-[3-(2H-Benzotriazol-2-yl)-4-hydroxyphenyl]ethyl methacrylate is both a monomer and an optical absorber.

### EXAMPLE 2

A resin was made using poly thioxanthone with a poly amine. Both constituents have high molecular weight and showed very limited diffusion into the PDMS.

### EXAMPLE 3

A resin was made using poly thioxanthone with a diffusible coinitiator such as borate or tertiary amine. Here, only the polythioxanthone has decreased solubility in PDMS.

### EXAMPLE 4

A resin of the following composition was made:
77.8 wt % Glycerol 1,3-diglycerolate diacrylate
19.5 wt % PEG575 Diacrylate
1.2 wt % TPO photoinitiator
1.5 wt % 2-[3-(2H-Benzotriazol-2-yl)-4-hydroxyphenyl]ethyl methacrylate

The effect of a polar resin on a PDMS window was demonstrated. On a printer with an intensity of 18 mW/cm² (from a 405 nm LED), 1500 layers were printed at which time there was a very slight cloudiness to the PDMS window. Thus, just using polar monomers increased the life of the PDMS window as compared to a nonpolar resin as in Example 1. Glycerol 1,3-diglycerolate diacrylate swelled PDMS 0.05 wt % and PEG575DA swelled the PDMS 1.3 wt %.

### EXAMPLE 5

A polar resin was made using a polar initiator such as lithiated TPO.

### EXAMPLE 6

The following procedure was used to make an oligomeric-TPO based photoinitiator. Dissolved 16.9 g NaI into 50 g dry acetone, then added 33.1 g TPO-L (Ethyl (2,4,6-trimethylbenzoyl) phenylphosphinate) and then heated at 50 C. for 14 hours. Filtered the precipitate and washed with cold acetone. Let the precipitate dry, then added deionized water until precipitate dissolved (about 4 liters) and filtered off any undissolved precipitate and discarded. Took the solution of water and slowly added HCl until no further precipitate crashed out (pH will be around 1 to 3). Filtered and dried the precipitate. The precipitate was the TPO-L with the ethyl group replaced by a hydrogen to form the acid (TPO-OH). Took 52.3 g TPO-OH and mixed with 47.7 g PEG500 diglycidyl ether (Aldrich 475696), once dissolved, added catalyst 1,8-Diazabicyclo[5.4.0]undec-7-ene (DBU) and heated to 50 C. for 14 hours. All epoxide groups were reacted (confirmed by nmr and FTIR) and no TPO-L was present (TLC on silica with 1 wt % ethyl acetate in dichloromethane as eluent). The final product is a pale yellow viscous liquid with molecular weight greater than 700 g/mole (depends on whether 1 or 2 equivalents of TPO-OH reacted onto the PEG500 diglycidyl ether).

### EXAMPLE 7

A resin of the following composition was made:
74.6 wt % Dimethylol tricyclodecane diacrylate
18.7 wt % Tripropyleneglycol diacrylate
3.5 wt % 2-[3-(2H-Benzotriazol-2-yl)-4-hydroxyphenyl]ethyl methacrylate
3.3 wt % Oligomer TPO from Example 6

Here, an oligomeric TPO derivative replaces the standard TPO photoinitiator at a concentration that matches the absorbance of TPO from Example 1. The printer printed 1500 layers (intensity at 405 nm was 18 mW/cm²) at which time there was a slight cloudiness to the PDMS window (Sylgard 184). This example demonstrates that by lowering the solubility of the photoinitiator in PDMS, the life of the window was extended as compared to Example.

### EXAMPLE 8

A resin of the following composition was made:
77.8 wt % Glycerol 11,3-diglycerolate diacrylate
19.5 wt % PEG575 diacrylate
3.3 wt % Oligomeric TPO from example 6
1.5 wt % 2-[3-(2H-Benzotriazol-2-yl)-4-hydroxyphenyl]ethyl methacrylate

Here, the printer (at 18 mW/cm² and 405 nm) printed 6000 layers with no visible clouding of the PDMS. The life of the PDMS window was increased dramatically over the results given in example 4, thus demonstrating the positive effect of using higher molecular weight photoinitiators.

### EXAMPLE 9

Polar or standard resin was made with a polymeric TPO having molecular weight greater than 1500 g/mol and including polar groups such as amides. The number of printed layers before clouding was greater than that seen in Examples 1 or 4.

All documents, patents, journal articles and other materials cited in the present application are hereby incorporated by reference.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments of the invention have been described, and it is to be understood that various changes and modifications may be apparent to those skilled in the art. Such changes and modifications are to be understood as included within the scope of the present invention as defined by the appended claims, unless they depart therefrom.

What is claimed is:

1. A system for making a three-dimensional object by solidifying a resin material, comprising:
a transparent window;
a build platform positioned above the transparent window and configured to move away from the transparent window as a solidifying region is defined between the build platform and the transparent window;
a light source configured to emit light through the window and toward the solidifying region; and
a resin container configured to supply the resin material to the solidifying region, the resin material comprising:
a polymerizable component including one or more monomers that have at least one polymerizable functional group, and
a photoiniator component that is activatable upon exposure to light having a wavelength between 200 nm and 800 nm, the photoiniator component including at least one polar component, the polar component including one or more polar groups that lower the solubility of the photoiniator component in the transparent window,
wherein, in use, a portion of the resin material in the solidifying region solidifies upon exposure to the light from the light source, and the solidified portion of the resin material is moved away from the transparent window along with the build platform.

2. The system of claim 1, wherein the photoiniator component has a molecular weight greater than 450 g/mol.

3. The system of any of claim 1, wherein the one or more monomers of the polymerizable component are nonpolar.

4. The system of any of claim 1, wherein a solubility of the polymerizable component in the transparent window is greater than the solubility of the photoiniator component in the transparent window.

5. The system of any of claim 1, wherein the photoiniator component includes diphenyl(2,4,6-trimethylbenzoyl)phosphine oxide (TPO).

6. The system of any of claim 1, wherein the photoiniator component is substantially activatable only upon exposure to light having a wavelength between 200 nm and 480 nm.

7. The system of any of claim 1, wherein the photoiniator component is substantially activatable only upon exposure to light having a wavelength between 350 nm and 410 nm.

8. The system of any of claim 1, wherein the build platform is configured to move in a horizontal plane parallel to the transparent window.

9. The system of any of claim 1, wherein the transparent window is made from polydimethylsiloxane (PDMS).

10. The system of any of claim 1, wherein the solidified portion of the resin material and the build platform are configured to, in use, move vertically away from an uncured layer of the resin material disposed at an upper surface of the transparent window.

11. A system for making a three-dimensional object by solidifying a resin material, comprising:
a transparent window;
a build platform positioned above the transparent window and configured to move away from the transparent window as a solidifying region is defined between the build platform and the transparent window;
a light source configured to emit light through the window and toward the solidifying region; and
a resin container configured to supply the resin material to the solidifying region, the resin material comprising:
a polymerizable component including one or more monomers that have at least one polymerizable functional group, and
a photoiniator that is activatable upon exposure to light having a wavelength between 200 nm and 800 nm, the photoiniator comprises at least one component having a molecular weight greater than 300 g/mol,
wherein, in use, a portion of the resin material in the solidifying region solidifies upon exposure to the light from the light source, and the solidified portion of the resin material is moved away from the transparent window along with the build platform.

12. The system of claim 11, wherein the at least one photoiniator component has a molecular weight greater than 450 g/mol.

13. The system of claim 11, wherein the at least one photoiniator component has a molecular weight greater than 500 g/mol.

14. The system of claim 11, wherein the at least one photoiniator component has a molecular weight greater than around 1000 g/mol.

15. The system of claim 11, wherein the at least one photoiniator component has a molecular weight greater than 1500 g/mol.

16. The system of any of claim 11, wherein the photoiniator includes at least one polar component, the polar component including one or more polar groups that lower the solubility of the photoiniator component in the transparent window.

17. The system of any of claim 11, wherein the one or more monomers of the polymerizable component are nonpolar.

18. The system of any of claim 11, wherein a solubility of the polymerizable component in the transparent window is greater than the solubility of the photoiniator in the transparent window.

19. The system of any of claim 11, wherein the photoiniator includes polymeric diphenyl(2,4,6-trimethylbenzoyl)phosphine oxide (TPO).

20. The system of any of claim 11, wherein the photoiniator is substantially activatable only upon exposure to light having a wavelength between 200 nm and 480 nm.

21. The system of any of claim 11, wherein the photoiniator is substantially activatable only upon exposure to light having a wavelength between 350 nm and 410 nm.

22. The system of any of claim 11, wherein the build platform is configured to move in a horizontal plane parallel to the transparent window.

23. The system of any of claim 11, wherein the transparent window is made from polydimethylsiloxane (PDMS).

24. The system of any of claim 11, wherein the solidified portion of the resin material and the build platform are configured to, in use, move vertically away from an uncured layer of the resin material disposed at an upper surface of the transparent window.

25. A resin for use in a system for making a three-dimensional object, the resin comprising:
a polymerizable component including one or more monomers that have at least one polymerizable functional group; and
a photoiniator component that is activatable upon exposure to light having a wavelength between 200 nm and 800 nm, the photoiniator component including at least one polar component,
wherein the resin is configured to solidify upon exposure to light from a light source of the system for making the three-dimensional object.

26. The resin of claim 25, wherein the photoiniator component has a molecular weight greater than 450 g/mol.

27. The resin of any of claim 25, wherein the one or more monomers of the polymerizable component are nonpolar.

28. The resin of any of claim 25, wherein a solubility of the polymerizable component in a transparent window of the system for making the three-dimensional object is greater than the solubility of the photoiniator component in the transparent window.

29. The resin of any of claim 25, wherein the photoiniator component includes diphenyl(2,4,6-trimethylbenzoyl)phosphine oxide (TPO).

30. The resin of any of claim 25, wherein the photoiniator component is substantially activatable only upon exposure to light having a wavelength between 200 nm and 480 nm.

31. The resin of any of claim 25, wherein the photoiniator component is substantially activatable only upon exposure to light having a wavelength between 350 nm and 410 nm.

32. A resin for use in a system for making a three-dimensional object, the resin comprising:
a polymerizable component including one or more monomers that have at least one polymerizable functional group, and
a photoiniator that is activatable upon exposure to light having a wavelength between 200 nm and 800 nm, the photoiniator comprises at least one component having a molecular weight greater than 300 g/mol,
wherein the resin is configured to solidify upon exposure to light from a light source of the system for making the three-dimensional object.

33. The resin of claim 32, wherein the at least one photoiniator component has a molecular weight greater than 450 g/mol.

34. The resin of claim 32, wherein the at least one photoiniator component has a molecular weight greater than 500 g/mol.

35. The resin of claim 32, wherein the at least one photoiniator component has a molecular weight greater than around 1000 g/mol.

36. The resin of claim 32, wherein the at least one photoiniator component has a molecular weight greater than 1500 g/mol.

37. The resin of any of claim 32, wherein the photoiniator includes at least one polar component, the polar component including one or more polar groups that lower the solubility of the photoiniator component in a transparent window of the system for making the three-dimensional object.

38. The resin of any of claim 32, wherein the one or more monomers of the polymerizable component are nonpolar.

39. The resin of any of claim 32, wherein a solubility of the polymerizable component in a transparent window of the system for making the three-dimensional object is greater than the solubility of the photoiniator in the transparent window.

40. The resin of any of claim 32, wherein the photoiniator includes polymeric diphenyl(2,4,6-trimethylbenzoyl)phosphine oxide (TPO).

41. The resin of any of claim 32, wherein the photoiniator is substantially activatable only upon exposure to light having a wavelength between 200 nm and 480 nm.

42. The resin of any of claim 32, wherein the photoiniator is substantially activatable only upon exposure to light having a wavelength between 350 nm and 410 nm.
